(19) United States
(12) Patent Application Publication
(10) Pub. No.: US 2008/0080028 A1
(43) Pub. Date: Apr. 3, 2008

(54) Imaging method, apparatus and system having extended depth of field

(75) Inventors: Dmitry Bakin, San Jose, CA (US); Scott T. Smith, Saratoga, CA (US); Kartik Venkataraman, San Jose, CA (US)

Correspondence Address: DICKSTEIN SHAPIRO LLP, 1825 EYE STREET, NW, WASHINGTON, DC, 20006, US

(73) Assignee: MICRON TECHNOLOGY, INC.

(21) Appl. No.: 11/540,673

(22) Filed: Oct. 2, 2006

(51) Int. Cl. H04N 1/46

(52) U.S. Cl. 358/514

(57) ABSTRACT

Various exemplary embodiments of the invention provide an extended depth of field. One embodiment provides an image restoration procedure, comprising determining sample point pixels from a pixel array based upon a distance of an object being imaged to the pixel array, and reading intensities of the sample point pixels into a memory. Another embodiment provides an image capture procedure comprising capturing light rays on a pixel array of an imaging sensor, wherein specific sampling point pixels are selected to be evaluated based on spread of an image spot across a based on spread of an image spot across the plurality of pixels of the pixel array plurality of pixels of the pixel array.

### FIELD OF THE INVENTION

Disclosed embodiments of the invention relate generally to the field of semiconductor devices and more particularly to a method, apparatus and system employing multi-array imager devices.

### BACKGROUND OF THE INVENTION

The semiconductor industry currently produces different types of semiconductor-based image devices which employ pixel arrays based on charge coupled devices (CCDs), CMOS active pixel sensors (APS), and charge injection devices, among others. These image devices use micro-lenses to focus electromagnetic radiation onto photo-conversion devices, e.g., photodiodes. Also, these image sensors often use color filters to pass particular wavelengths of electromagnetic radiation for sensing by the photo-conversion devices, such that the photo-conversion devices are typically associated with a particular color.

Micro-lenses help increase optical efficiency and reduce crosstalk between pixels of a pixel array. FIGS. 16A and 16B show a top view and a simplified cross sectional view of a portion of a conventional color image device pixel array 10 using a Bayer color filter pattern. The array 10 includes pixels 12, each being formed over a substrate 14. Each pixel 12 includes a photo-conversion device 16, for example, a photodiode having an associated charge collecting region 18. The illustrated array 10 has micro-lenses 20 that collect and focus light on the photo-conversion devices 16 which generate electrons which are accumulated and stored in the respective charge collecting regions 18.

The array 10 can also include a color filter array 22. The color filter array 22 includes color filters 24 each disposed over a respective pixel 12. Each of the filters 24 allows only particular wavelengths of light to pass through to a respective photo-conversion device. Typically, the color filter array 22 is arranged in a repeating color filter pattern known as a Bayer pattern which includes two green color filters for every red color filter and blue color filter, as shown in FIG. 16A.

Between the color filter array 22 and the pixels 12 is an interlayer dielectric (ILD) region 26. The ILD region 26 typically includes multiple layers of interlayer dielectrics and conductors that form connections between devices of the pixels 12 and from the pixels 12 to circuitry 28 peripheral to the pixel array 10. A dielectric layer 30 is also typically provided between the color filter array 22 and micro-lenses 20.

One disadvantage of a pixel array, particularly a small size array of high density, is that it is difficult to capture an image having objects at various distances from the pixel array such that all are in focus. Thus, depth of field, which is the distance between the nearest and farthest objects that appear in acceptably sharp focus, could be improved. One phenomenon contributing to a reduced depth of field is the lens system which focuses an image on the pixel array. Another contributing factor, particularly for pixel arrays having pixels of small size, is crosstalk among the pixels. Crosstalk can occur in two ways. One source of optical crosstalk is when light enters a micro-lens at a wide angle and is not properly focused on the correct pixel. An example of angular optical crosstalk is shown in FIG. 16B. Most of the filtered light 32 reaches the intended photo-conversion device 16, but some of the filtered red light 32 is misdirected to adjacent pixels 12.

Electrical crosstalk can also occur in the pixel array 10 through, for example, a blooming effect. Blooming occurs when a light source is so intense that the charge collecting regions 18 of the pixel 12 cannot store any more electrons and excess electrons flow into the substrate 14 and into adjacent charge collecting regions 18. Where a particular color, e.g., red, is particularly intense, this blooming effect can artificially increase the response of adjacent green and blue pixels.

A method, apparatus and system for improving the depth of field of a solid state imager is desired.

### BRIEF DESCRIPTION OF THE DRAWINGS

FIG. 1 is an illustration of light rays passing through an optical imaging lens;

FIG. 2 is a representation of light rays on a pixel array;

FIG. 3 is a graph showing the relationship between an object and image positions;

FIG. 4 is a top plan view of multiple 3×1 pixel arrays according to an embodiment of the invention;

FIG. 5 is a cross sectional view of the multiple pixel arrays of FIG. 4;

FIG. 6A is a cross sectional view of an image sensor according to an embodiment of the invention;

FIG. 6B is a top view of an image sensor of FIG. 6A;

FIG. 7A is a cross sectional view of an image sensor according to an embodiment of the invention;

FIG. 7B is a top view of an image sensor of FIG. 7A;

FIG. 8A is a cross sectional view of an image sensor according to an embodiment of the invention;

FIG. 8B is a top view of an image sensor of FIG. 8A;

FIG. 9A is a representation of a pixel array according to an embodiment of the invention;

FIG. 9B is a representation of a pixel cluster according to an embodiment of the invention;

FIG. 10 is a representation of a pixel array according to an embodiment of the invention;

FIG. 11 is a representation of a line buffer memory according to an embodiment of the invention;

FIG. 12 is a flowchart representing an image restoration process according to an embodiment of the invention;

FIG. 13 is a representation of a processor employing the image restoration process of an embodiment of the invention;

FIGS. 14A-14C are representations of applications of the process of FIGS. 12 and 13 to the device of FIGS. 4 and 5.

FIG. 14D is a representation of an application of the process of FIGS. 12 and 13 to the device of FIGS. 16A and 16B.

FIG. 15 is a representation of a system employing embodiments of the invention;

FIG. 16A is a top plan view of a portion of a convention Bayer pattern color image sensor; and

FIG. 16B is cross sectional view the image sensor of FIG. 14A.

### DETAILED DESCRIPTION OF THE INVENTION

In the following detailed description, reference is made to the accompanying drawings, which form a part hereof and illustrate specific embodiments of the invention. In the drawings, like reference numerals describe substantially similar components throughout the several views. These embodiments are described in sufficient detail to enable those skilled in the art to practice the invention, and it is to be understood that other embodiments may be utilized, and that structural, logical and electrical changes may be made.

The term “pixel” refers to a picture element unit cell containing a photo-conversion device for converting electromagnetic radiation to an electrical signal. Typically, the fabrication of all pixel cells in a pixel array will proceed concurrently in a similar fashion.

The invention in the various disclosed method, apparatus and system embodiments takes advantage of advances in imaging technology which provides sensors with sub-micron pixel sizes and lens arrays. Embodiments of the invention provide a combination of a novel integrated color sensor array with a novel image restoration technique. According to disclosed embodiments, differences in converging rays are identified for objects at different focal distances, and image information at different focal distances is selected and used to recreate an image having an extended depth of field.

A typical imaging module incorporates an imaging lens, a photosensitive pixel array and associated circuitry peripheral to the array. The imaging lens is aligned within a mounting barrel—the space within which the imaging lens moves toward and away from the senor. The imaging lens is secured at a certain focusing distance from the surface of the sensor to provide a sharp image of distant objects in the focal plane. The front focal point of an optical system, by definition, has the property that any ray that passes through it will emerge from the system parallel to the optical axis. The rear focal point of the system has the reverse property: rays that enter the system parallel to the optical axis are focused such that they pass through the rear focal point.

The front and rear focal planes are defined as the planes, perpendicular to the optical axis, which pass through the front and rear focal points. An object an infinite distance away from the optical system forms an image at the rear focal plane. The rear focal plane, generally, is the plane in which images of points in the object field of the lens are focused. In a typical digital still or video camera, the pixel array is typically located at the rear focal plane.

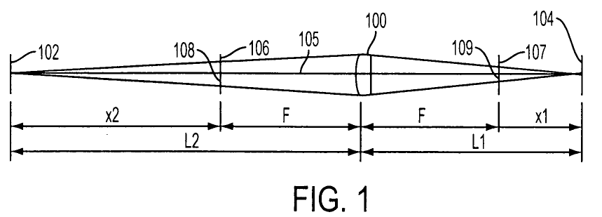

When an object to be imaged moves closer to the imaging lens, the image is shifted behind the rear focal plane of the imaging lens. With reference to FIG. 1, distance L1 is the distance between the image 104 and the imaging lens 100, and distance L2 is the distance between the imaging lens 100 and the object 102 being imaged. F is the focal length, which is the distance from the imaging lens 100 to front focal point 106 and rear focal point 107. The front focal point 106 lies in front focal plane 108, and the rear focal point 107 lies in rear focal plane 109. The relationship between distances L1 and L2, and the focal length F is given by the following mathematical expression:

$$\frac{1}{L 1} + \frac{1}{L 2} = \frac{1}{F} \qquad ( 1 )$$

Thus, for each different distance L2, from the imaging lens 100 to the object 102, there is a corresponding distance L1 from the imaging lens 100 to the image 104. The distances L1 and L2 can also be represented by distances x1 and x2 together with the focal distance F. The distance x2 corresponds to the distance from the object 102 to the front focal point 106 in front of the imaging lens 100. The distance x1 corresponds to the distance from the image 104 to the rear focal point 107 behind the imaging lens 100. An alternative of mathematical expression (1) can be written in a Newtonian form:

x1×x2=F² (2)

For the image 104 to be in focus, the distance x1 should be zero (x1=0). When the distance x1 is zero, the image 104 at the rear focal point 107. This always occurs when the object 102 is at infinity (x2=∞). When the object 102 moves closer toward the imaging lens 100, the image 104 moves out of focus, so that

x1=F²/x2 (2a)

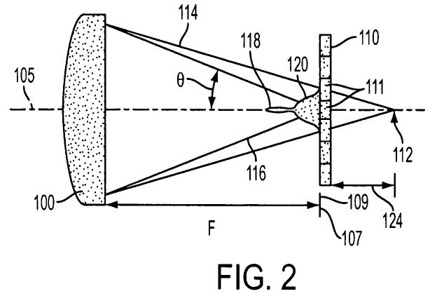

A typical arrangement of an imaging lens and a pixel array is shown in FIG. 2. The pixel array 110 is located at the rear focal point 107 of the imaging lens 100, or along the rear focal plane 109. The rear focal plane 109 is perpendicular to the optical axis 105. When the image 104 is shifted behind the rear focal plane 109 of the imaging array 110 (to the right in FIG. 2), converging light rays forming the image 104 are spread out over several pixels of the array and create a blurred area on the sensor. At this stage, the Point Spread Function (PSF) spot of the optical system has increased. PSF is a resolution metric that measures the amount of blur introduced into a recorded image. It provides a metric for determining the degree to which a perfect point from a source in an original scene is blurred in a recorded image. Increased PSF corresponds with reduction in resolution and modulation transfer function (MTF), which is a parameter characterizing the sharpness of a photographic imaging system or of a component of the system.

When the PSF area exceeds the size of a pixel, an image starts to become blurred. With reference to FIG. 2, an imaging array 110 is shown located at a focal distance F behind the imaging lens 100. The imaging array 110 has multiple pixels 111. In FIG. 2 light rays 116, at an angle θ from the axis 105, converge at a single pixel 111 of the imaging array 110. Light rays 116 produce an in-focus spot 118. On the other hand, light rays 114 converge at a point 112 behind the imaging array 110. The converging light rays 116 spread into neighboring pixels 111 of the imaging array 110, and produce an out of focus spot 120. One should distinguish between a monochrome sensor, where the size of pixels 111 corresponds to the actual pixel size, and a color sensor that uses a Bayer CFA pattern, where the size of pixels 111 corresponds to twice the pixel size for red and blue pixels, and 1.41 times the pixel size for green pixels.

The axial shift of the image plane from the imaging array 110 to point 112, where the light rays 114 converge is characterized by the appearance of a pixel blur. Depth of field is the amount of distance between the nearest and farthest objects that appear in acceptably sharp focus in an optical system. Depth of Field is also known as the hyper-focal distance. In FIG. 2, the axial shift of the image plane is shown by numeral 124. Referring back to FIG. 1, the axial shift 124 can be expressed as distance x1 in the following mathematical expression:

x1=F²/af# (3)

In equation (3), a is the pixel size and f# (f number) is a measured characteristic of an imaging lens. In an imaging system, a certain amount of axial shift x1 is acceptable within a range in which the image of an object remains in focus without adjustment to the imaging lens. The distance x1 corresponds to a focus-free distance, or the distance up to which an object remains in focus without adjusting the position of the imaging lens. That is, when the object to be imaged is positioned anywhere from infinity to the distance x1 from the image sensor, no adjustment in needed to the imaging lens to bring the object into focus.

As an example, if an imaging device has a pixel array pixel size a=7.2 Mm, and an imaging lens having a focal length F=2.5 mm, and f#=2.8, the focus-free object plane distance x1=310 mm. This results in an operational focus-free range (FFR) of the system being from infinity (∞) to 310 mm. Without adjusting imaging lens position, objects from infinity to 310 mm away from the imaging array will be in focus. Thus, such an imaging device would have a DOF=±20 μm. DOF is approximately equal to a multiplied by f#. For such an imaging device, objects for which defocused images are shifted from their nominal position (at ∞) by less then 20 μm will look focused.

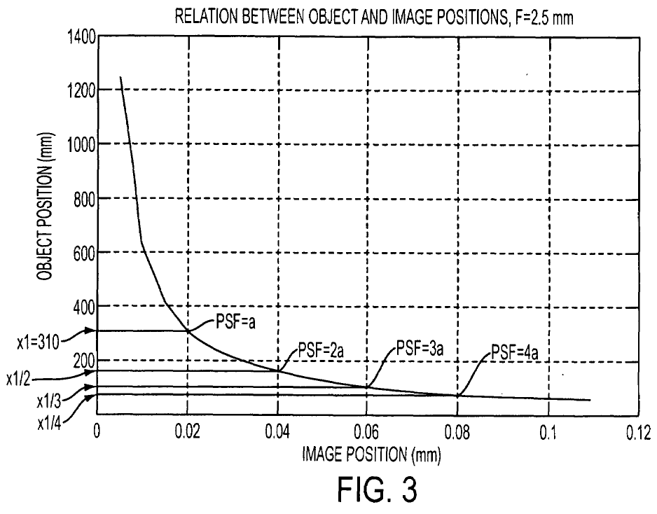

FIG. 3 provides a graphical illustration of the above example. In the above example, the imaging device has a focal distance F=2.5 mm, pixel size a=7.2 μm, and f#=2.8. The graph in FIG. 3 illustrates that the imaging module can provide a sharp image, without focus adjustment to the imaging lens, for objects positioned between infinity and x1=310 mm. At x1=310 mm, the PSF is equal to the pixel size a, and the image is sharp. When the object moves closer to the camera's imaging lens, within less than 310 mm, the PSF gets larger, and the image shifts out of focus at an accelerating, hyperbolic rate.

As shown in equation (3) above, the distance x1 is proportional to the square of the focal distance F. Therefore, it is advantageous to use an imaging lens assembly with a shorter focal distance F. A shorter focal distance F results in a smaller distance x1, and subsequently allows objects closer to the imaging lens without getting out of focus, thus extending DOF.

The method, apparatus and system embodiments disclosed herein incorporate novel pixel array, pixel sampling, and image construction techniques which are discussed in more detail below, to increase the depth of field associated with solid state imagers.

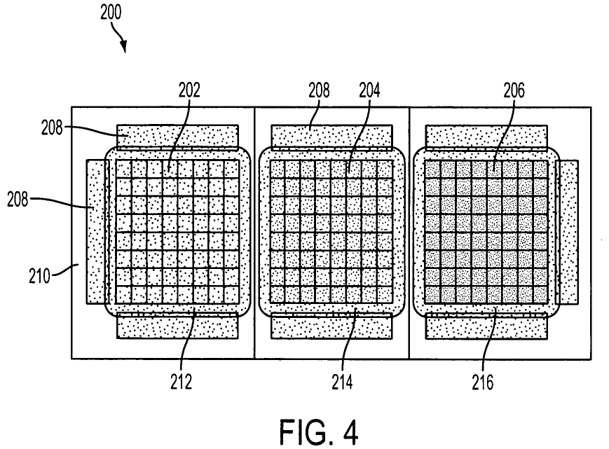

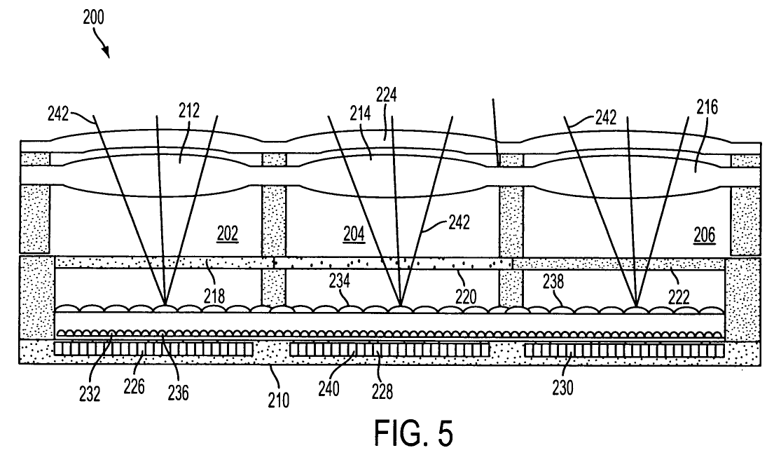

With reference to FIGS. 4 and 5, an embodiment of a novel pixel array for an imager device 200 is shown in top and cross-sectional views, respectively. The imager device 200 comprises multiple color pixel arrays, e.g., a green pixel array 202, a red pixel array 204 and a blue pixel array 206 arranged in a linear 3×1 configuration. Alternatively, the color pixel arrays can be arranged in 2×2 configuration, in which there are two green pixel arrays 202, or other configurations.

The arrays 202, 204, 206 have associated imaging lenses 212 (green), 214 (red) and 216 (blue). In one embodiment, the multiple pixel arrays are integrated on a single integrated circuit die, or chip 210. The single integrated die 210 also has peripheral support circuitry 208 for operating the multiple color pixel arrays 202, 204, 206 and providing pixel output signals therefrom. Color filters 218 (green), 220 (red) and 222 (blue) are provided between a mini-lens array 234 and the optical elements 224. Alternatively, color filters 218, 220, 222 can be provided on the surface of the pixel arrays 226, 228, 230, or incorporated into optical elements 224 respectively associated with a pixel array. The color pixel arrays 226, 228, 230 allow later formation of a full-color image from individual color images captured by the pixel arrays 226, 228, 230.

Each imaging lens 212, 214, 216 projects an image of an object onto the corresponding pixel arrays 226, 228, 230 of the imaging device 200. In one embodiment a micro-lens array 232 is provided for each pixel array 226, 228, 230. The micro-lens array 232 comprises individual micro-lenses 236 provided above each individual pixel 240 in order to focus and channel the incident light rays onto photosensitive area of the pixel 240.

As known in the art, subdividing a single imaging device 200 into three color pixel arrays 226 (green), 228 (red) and 230 (blue) allows for an effective reduction of the original imaging lens focus by half. The effective color pixel size is also reduced by one half, and allows the resolution of imaging device to be maintained. According to equation (3) above, the minimum focus-free distance in this case is reduced by one half.

The embodiment illustrated in FIGS. 4 and 5 has a mini-lens array 234 provided over the micro-lens array 232 and each pixel array 226, 228, 230. Each individual mini-lens 238 covers at least a 2×2 cluster, and preferably a 3×3 cluster of pixels 240 of the corresponding pixel array 226, 228, 230. The mini-lens array 234 is located at approximately the focal plane of the imaging lenses 212, 214, 216.

Each mini-lens 238 of array 234 is located, for example, such that its edges are aligned with three of the underlying micro-lenses 236. In this arrangement each mini-lens 238 covers a 3×3 cluster of nine micro-lenses 236. The lateral alignment of the mini-lens array 234 relative to the underlying micro-lenses 236 compensates for shifts of Chief Rays from center positions of an imaging lens. A Chief Ray is defined as a light ray that travels from a specific field point, through the center of the entrance pupil, and onto the image plane.

The numerical aperture (NA) of the mini-lenses 238 is preferably equal to the numerical aperture of the imaging lenses 212, 214, 216. During assembly, the mini-lens array 234 is positioned over the micro-lens array 232 during fabrication of the imaging sensor 200. The process for manufacturing the mini-lens array 234 is similar to that for manufacturing the micro-lens array 232, and is generally known in the art. Accurate alignment of the mini-lens array 234 is preferably achieved through utilization of precision photolithographic masks and tools, using techniques know in the art.

As shown in FIG. 5, the molded optical elements 224 are disposed above the color pixel arrays 226, 228, 230. Each imaging lens 212, 214, 216 is optimized for one of the primary spectral regions. The spectral regions are selected by red, green, or blue filters 218, 220, 222. The mini-lens array 234 is positioned approximately at the focal plane of the imaging lenses 212, 214, 216. The micro-lens array 232 is placed close to the focal plane of mini-lenses 238 of the mini-lens array 234.

In use, the imaging lenses 212, 214, 216 focus light rays 242 from a remote object spot onto the surface of the mini-lens array 234. In turn, each of the mini-lenses 238 of the mini-lens array 234 directs incident rays to the micro-lenses 236 of the micro-lens array 232. The micro-lenses 236 channel the light rays 242 to the corresponding pixels 240 underneath the micro-lenses 236.

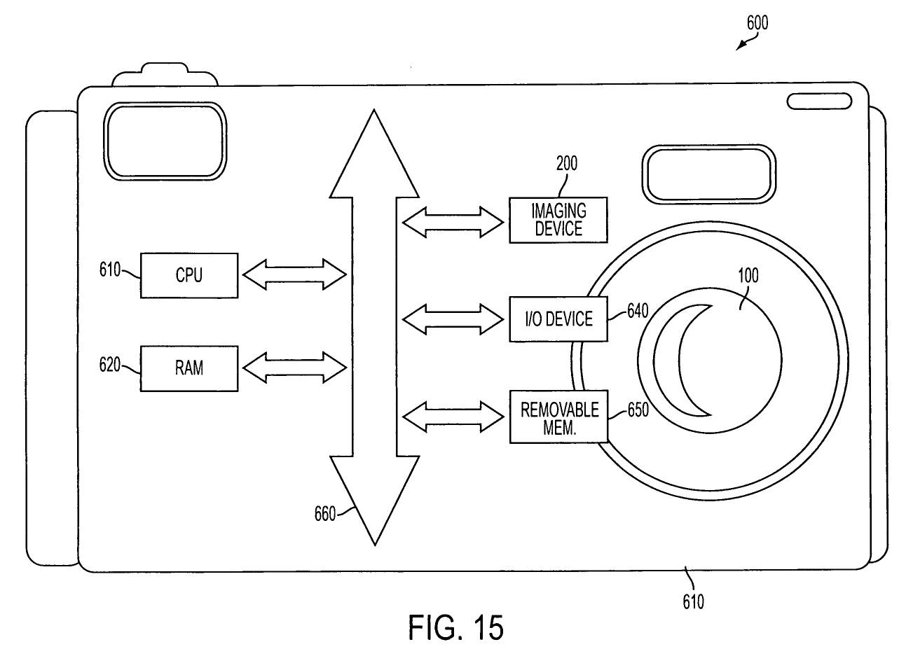

An embodiment of an image restoration process is described below. The image restoration process utilizes particular sample point pixels of a pixel array to reconstruct an image. The process may be implemented for an imaging device 200 shown in FIGS. 4 and 5 which has three separate color pixel arrays 202, 204, 206. For the imaging device 200, the process can be implemented by first combining the signals of the green, red and blue pixel arrays 202, 204, 206, into one combined array comprising green, red and blue signal information, and then applying the process to the combined array. Alternatively, the process can first be applied to each color pixel array 202, 204, 206 individually, after which the restored green, red and blue image signals are combined to restore the final image. Moreover, the image restoration process could also be applied to a conventional pixel array 10, shown in FIG. 15A, that contains green, red and blue signals.

Referring again to FIG. 5, when an image spot in a scene is in focus, the light rays 242 converge on the surface of the particular mini-lens 238 and fully fill its numerical aperture (NA). The numerical aperture (NA) of an optical system is a dimensionless number that characterizes the range of angles over which the lens can accept or emit light. The result is that every pixel 240 under the mini-lens 238 receives some portion of light rays 242 from the focused image spot. The sum of the pixel outputs for pixels which receive the light rays represents the integrated light intensity of the imaged spot.

The resolution of the full image is limited to the number of mini-lenses 238. For higher resolution, each mini-lens 238 should cover less than the 3×3 cluster of nine pixels 240. However, in the embodiments described each mini-lens 238 covers at least a 3×3 cluster of pixels to facilitate the image restoration process, which will be discussed below. A preferred way to increase resolution would be to provide a bigger array of pixels, but at the same time provide an individual mini-lens 238 covering a 3×3 cluster of pixels 240, for example. Increasing the number of pixels 240 covered by each mini-lens 238, e.g., providing a mini-lens covering a 5×5 cluster of pixels, would increase depth of field information available, but would reduce resolution.

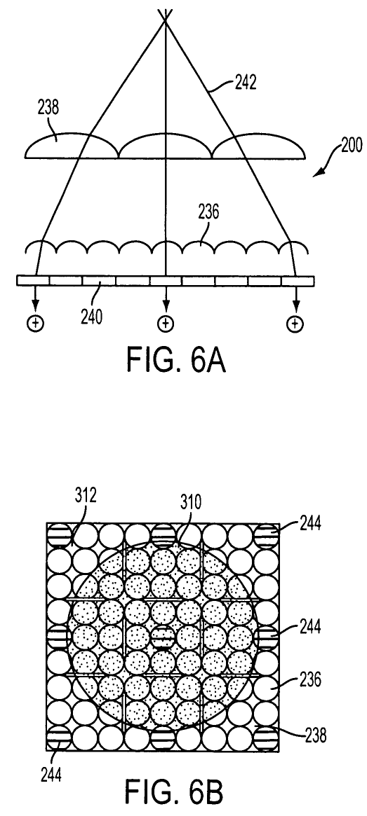

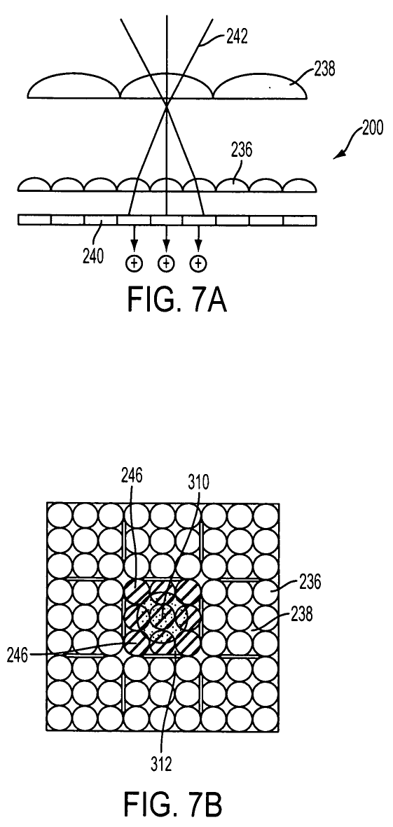

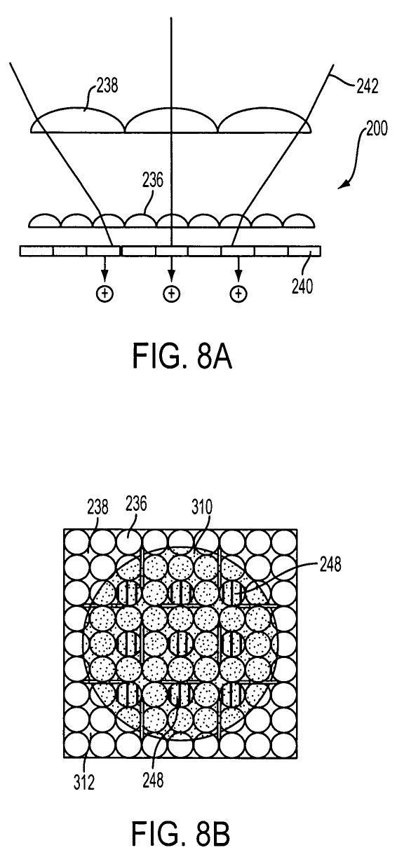

With reference to FIGS. 6A, 6B, 7A, 7B, 8A and 8B, paths of light rays 242 are shown for three different situations, each corresponding to light rays 242 from object spots at different distances from the imager device 200. FIGS. 6A, 7A and 8A show a side sectional view of the pixels 240, micro-lenses 236 and mini-lenses 238 of the imaging device 200. FIGS. 6B, 7B and 8B show corresponding top views of the imaging device 200, showing substantially square-shaped mini-lenses 238 each covering a 3×3 cluster 312 of nine micro-lenses 236 and associated underlying pixels 240. FIGS. 6A and 6B show a path of light rays 242 on the imaging device 200 when the object spot being imaged is far away from the imaging sensor. FIGS. 7A and 7B show a path of the light rays 242 on the imaging device 200 when the object spot being imaged is at a mid-range position from the imaging sensor. FIGS. 8A and 8B show a path of the light rays 242 on the imaging device 200 when the object spot is close to the imaging sensor. For purposes of illustration, exemplary distances for far, mid-range and close objects from the imaging device 200 are 10 meters, 1 meter and 10 centimeters, respectively.

Referring to FIGS. 6A, 6B, when an object is placed far from the imaging device 200, the image from a single spot of the imaged object is shifted behind the focal plane of imaging lenses 212, 214, 216, in accordance with equation (2a). At this stage, the image spot is spread over several mini-lenses 238. As a result, each of the mini-lenses 238 receives only a portion of the light rays 242 comprising the image spot 310. Stated another way, the full converging cone of light rays 242 from the imaging lenses 212, 214, 216 is now divided among several mini-lenses 238. The cone 310 of light rays 242 is incident on the middle mini-lens 238 and portions of the other mini-lenses 238 of the mini-lens array 234. When an object is far from the imaging device 200, the image from a single spot of the imaged object is positioned in front of the mini-lenses 238.

According to the image restoration process of the disclosed embodiments, which will be described in greater detail below, several pixels of a 9×9 group of imager pixels are selected as sample point pixels for use in selecting pixels for creating an image of the single spot of the far-away object. Location of the sample point pixels are chosen based on the angle of light rays 242 that comes in from the object spots. The total intensity corresponding to the particular image spot is obtained by summing outputs of the sample point pixels. The sample pixels are shown with horizontal hatching in FIG. 6B, and denoted by numeral 244.

FIGS. 7A and 7B illustrate light rays 242 from an object spot at mid-range position from the imaging device 200. The light rays 242 pass through a mini-lens 238 onto a 3×3 cluster 312 of micro-lenses 236 and underlying pixels 240. For an object at a mid-range distance from the imaging device 200, different pixels 240 from the 9×9 cluster of imager pixels are chosen as the sample point pixels for use in selecting pixels for creating the image. Referring to FIG. 7B, pixels marked with diagonal hatching are sample point pixels 246 used to determine the intensity corresponding to the particular image spot at a mid-range distance from the imaging device 200.

Referring to FIGS. 8A and 8B, light rays 242 are shown from an object spot that is close to the image sensor 200. Light rays 242 are spread over several mini-lenses 238. FIG. 8B shows a cone 310 of light rays 242 that is incident on the mini-lenses 238. The cone 310 of light rays 242 is incident on the middle mini-lens 238 and portions of the other mini-lenses 238 of the mini-lens array 234. The light rays 242 are transmitted by the mini-lenses 238 onto the underlying components as shown in FIG. 8A. For an object close to the imaging device 200, different pixels 240 from the 9×9 group of imager pixels are chosen as the sample point pixels for use in selecting pixels for creating the image. Referring to FIG. 8B, pixels marked with vertical hatching are sample point pixels 248 used to determine the intensity corresponding to the particular image spot close to the imaging device 200.

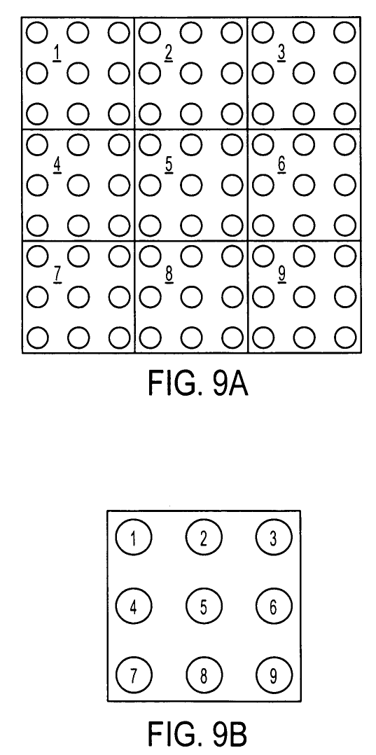

Positions of sample point pixels 244, 246, 248 within a 9×9 group of pixels will be explained with reference to FIGS. 9A and 9B. FIG. 9A is a representation of a 9×9 group of pixels. Within the 9×9 group of pixels there are nine 3×3 clusters of pixels, numbered 1 through 9 as shown in FIG. 9A. The clusters are positioned as follows: the upper left cluster is marked as 1; upper center cluster as 2; upper right cluster as 3; middle left cluster as 4; middle center cluster as 5; middle right cluster as 6; lower left cluster as 7; lower center cluster as 8; and lower right cluster as 9.

Each 3×3 cluster of pixels has nine pixels, and a 3×3 cluster of pixels is shown in FIG. 9B wherein each of the nine pixels is numbered 1 through 9. With reference to FIG. 9B, the position of each pixel within a 3×3 cluster of pixels is as follows: the upper left pixel is marked as 1; the upper center pixel as 2; the upper right pixel 3; the middle left pixel as 4; the middle center pixel as 5; the middle right pixel as 6; the lower left pixel as 7; the lower center pixel as 8; and the lower right pixel as 9.

Using the terminology discussed above with respect to FIGS. 9A and 9B, positions of sample point pixels 244, 246, 248 can be described. Positions of sample point pixels 244 shown in FIG. 6B are as follows: the upper left pixel in the upper left cluster; the upper center pixel in the upper center cluster; the upper right pixel in the upper right cluster; the middle left pixels in the middle left cluster; the middle center pixel in the middle center cluster; the middle right pixel in the middle right cluster; the lower left pixel in the lower left cluster; the lower center pixel in the lower center cluster; and the lower right pixel in the lower right cluster. These nine sample point pixels 244 are utilized to determine the spot intensity of an image of far objects focused in front of the sensor 200.

Positions of sample point pixels 246 shown in FIG. 7B are as follows: the upper left pixel in the middle center cluster; the upper center pixel in the middle center cluster; the upper right pixel in the middle center cluster; the middle left pixel in the middle center cluster; the middle center pixel in the middle center cluster; the middle right pixel in the middle center cluster; the lower left pixel in the middle center cluster; the lower center pixel in the middle center cluster; and the lower right pixel in the middle center cluster. These nine sample point pixels 246 are utilized to determine the spot intensity of an image of mid-range objects that are focused at the sensor.

Positions of sample point pixels 248 shown in FIG. 8B are as follows: the lower right pixel in the upper left cluster; the lower center pixel in the upper center cluster; the lower left pixel in the upper right cluster; the middle right pixel in the middle left cluster; the middle center pixel in the middle center cluster; the middle left pixel in the middle right cluster; the upper right pixel in the lower left cluster; the upper center pixel in the lower center cluster; and the upper left pixel in the lower right cluster. These nine sample point pixels 244 are utilized to determine the spot intensity of an image of close objects that are focused behind the sensor.

The image spots produced by far, mid-range, and close portions of objects in a scene, as illustrated in FIGS. 6-8, which represent possible light spread patterns for objects located at far, mid-range or close positions are used to select pixels to create the final image. Location of the sample point pixels 244, 246, 248 have been chosen based on the angle of light rays 242 that come in from out of focus object spots. In some cases it will be advantageous to apply weights to the sample pixel 244, 246, 248 outputs to account for the specific PSF intensity distribution of the imaging system.

The pixel clusters are not limited to 3×3 clusters 312. If each cluster comprises 5×5 pixels for example, the sample point pixels 244 are chosen from the same relative positions as in the above example, based on the angle of light rays at the pixels. Also, the mini-lens array 234 may be placed slightly behind the focal plane of the imaging lens at a distance x1=2af, where a is the size of a mini-lens in the mini-lens array. Objects positioned at distance x2=F²/2af# from the imaging lens will be at exact focus, and the focus-free range will be extended from infinity (∞) to x2=F²/4af#.

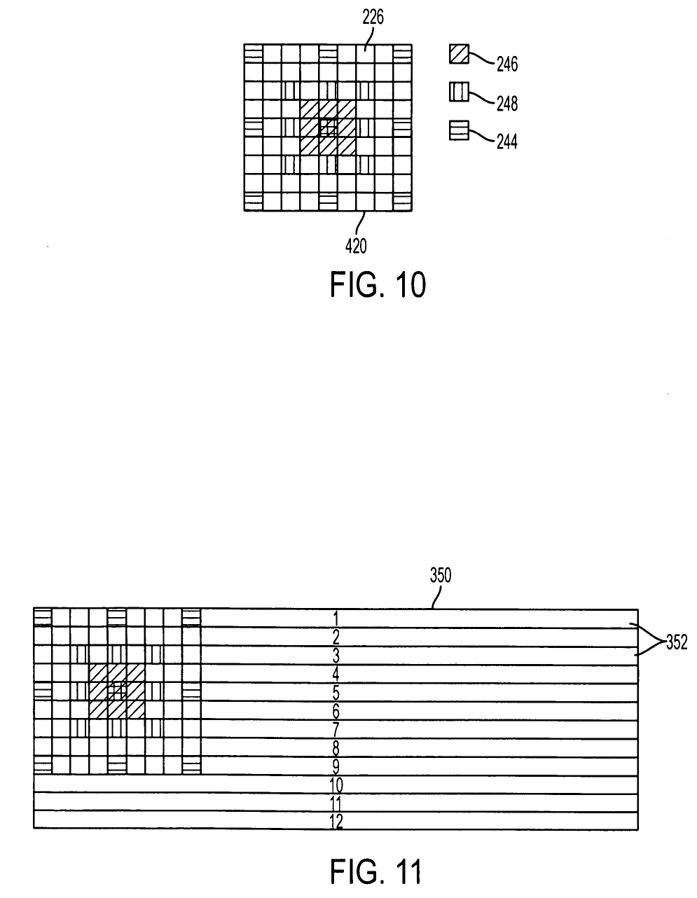

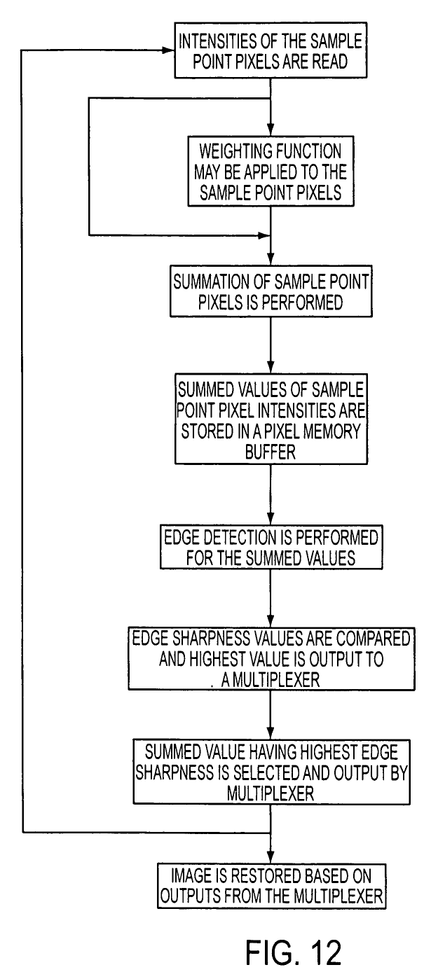

An embodiment of the image creation process will now be described. FIGS. 10 and 11 show block diagrams of pixel patterns utilized to construct image information for near, mid and far image planes. FIG. 10 shows a pixel selecting processing pattern 420 that is applied to each 9×9 group of pixels such that only the sample point pixels 244, 246, 248 are read into a memory to determine the characteristics of an image portion received by the 9×9 group of pixels.

The image creation process reads sampling point pixels 244, 246, 248 which respectively provide information for near, mid-range, and far planes of a scene. With reference to FIG. 11, a 9×9 group of pixels is read into a line buffer memory. In one embodiment a twelve (12) line buffer memory 350 is used to process information from the imaging device 200. Each row of pixels is read into a line of the line buffer memory 350. The pixel processing pattern 420 having the sample points 244, 246, 248 is applied to the 9×9 group of pixels in the memory 350 to extract three sets of 3×3 pixels, each corresponding to one of the pixel patterns 244, 246, 248. The three sets of 3×3 pixels are used to determine a different respective characteristic of an image portion within the 9×9 pixel group. The three (3) additional lines of the twelve line buffer memory 350 are used to read out pixel data while block image computations are performed.

After a 9×9 cluster of imager pixels is read, and the three sets of 3×3 pixels extracted, the pixel processing pattern 420 is shifted to a next 9×9 group of pixels of the pixel array loaded into memory 350, and additional sample point pixels 244, 246, 248 are extracted as three 3×3 sets of pixels. According to an embodiment, for example, the pixel processing pattern 420 is shifted horizontally by 3 pixels along the pixel array to process successive 9×9 groups of pixels. After reaching the end of the pixel array, the filter pattern 420 is shifted down by 3 pixels to process the next 9×9 group of pixels, and the process is carried out until an entire pixel array is sampled.

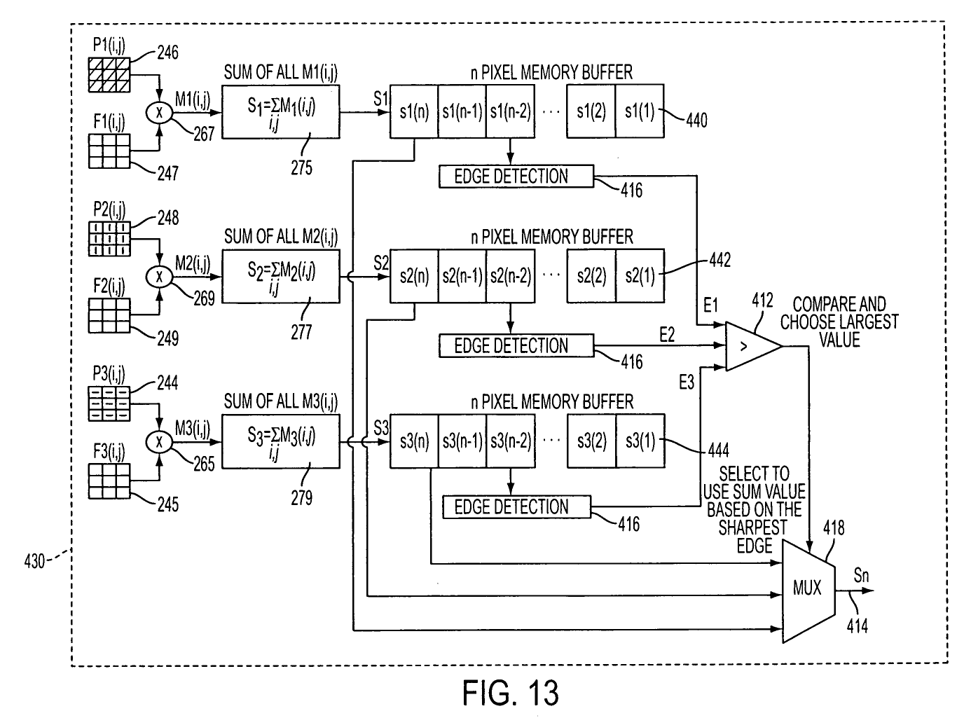

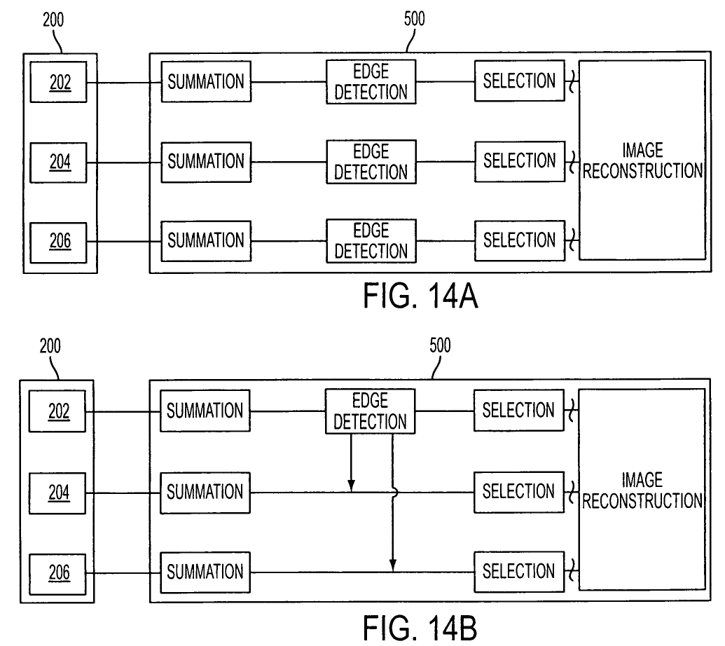

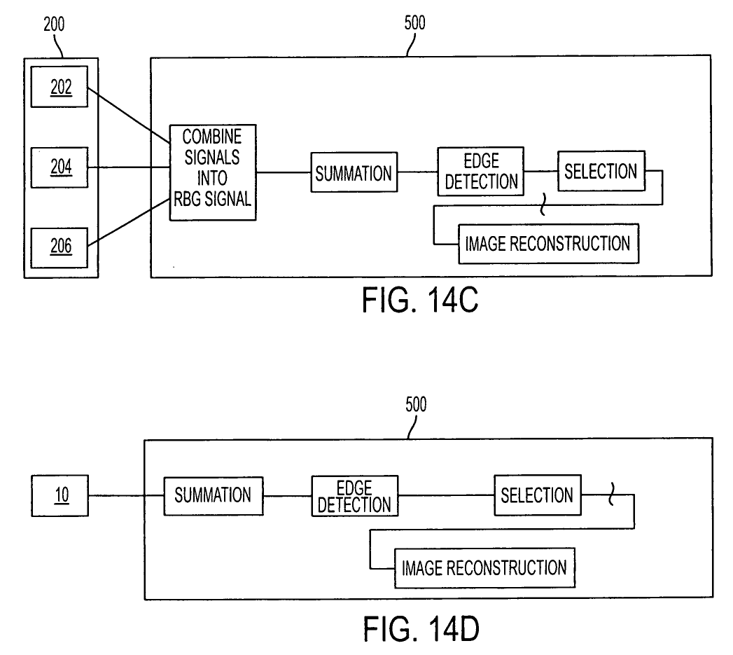

An exemplary image creation process, using the three 3×3 sets of extracted pixels corresponding to each 9×9 pixel group, is now described. The process may be implemented as a pixel processing unit 500 (FIGS. 14A-14D), and is now discussed with reference to FIGS. 12 and 13. The image creation technique comprises the following steps:

(a) intensities of the 3×3 sample point pixels 244, 246, 248 for each 9×9 group of pixels are read-out from line buffer memory 350;

(b) a respective weighting function 245, 247, 249 may be applied to the sample point pixels by multiplication units 265, 267, 269; the weighting function can be static or dynamic;

(c) a summation S1, S2 and S3 is performed by summation units 275, 277, 279 for the respective intensities of each of the (weighed) sample point pixels in each 3×3 pixel set 246, 248, 244;

(d) the summed values S1, S2 and S3 of sample point pixel intensities are successively stored in respective pixel buffer memories 440, 442, 444, buffer memories 440, 442, 444 store summed values representing each of the 9×9 groups of pixels as the summed sets of 3×3 pixel sample points, across an entire set of rows of an array;

(e) respective edge test units 416 applies an edge test to each of the stored summed values S1, S2, S3 to find sharpest edges between adjacent summed values of the successively stored summed values S1, S2, S3, and outputs edge sharpness values E1, E2 and E3, representing a sharpness degree, to a comparator 412;

(f) the comparator 412 compares values E1, E2 and E3 and outputs to a multiplexer 418 a signal corresponding to the highest edge sharpness value detected among the three values;

(g) for each edge sharpness value selected (one of E1, E2 or E3), multiplexer 418 selects a summed pixel value S1, S2 or S3 at the side of the edge having the higher value based upon which edge sharpness value E1, E2 and E3 is highest, and provides the selected summed sample pixel value as an output 414;

(h) steps (a) through (g) are repeated for all the 9×9 group of pixels of a pixel array; and

(i) after an entire pixel array is read, outputs 414, representing the summed S1, S2 or S3 selected values, one corresponding to each location of a 9×9 group of pixels in the pixel array, are used to reconstruct an image of the object.

As discussed above, the image creation process is applicable to the imaging device 200 having three color pixel arrays 202, 204, 204 (FIGS. 4 and 5). The image creation process is also applicable to a conventional pixel array 10, shown in FIG. 15A, that contains green, red and blue signals arranged in a pattern with the pixel processing unit demosaicing the color pixel signals prior to performing the process described above with respect to FIGS. 12 and 13.

With reference to FIG. 14A, a pixel processing unit 500 applies the image creation process respectively to each color pixel array 202, 204, 206. The processing unit 500 can be a hardware processing unit or a programmed processing unit, or a combination of both. Alternatively, as shown in FIG. 14B, the summation step of the process can be respectively applied to each color pixel array 202, 204, 206, and the edge detection step can be applied to only one color array, e.g., the green pixel array 202, with the summation S1, S2, S3 selected as a result of the edge detection step of the green pixel array 202 also used to select the summation results S1, S2 or S3 for the red and blue arrays 204, 206.

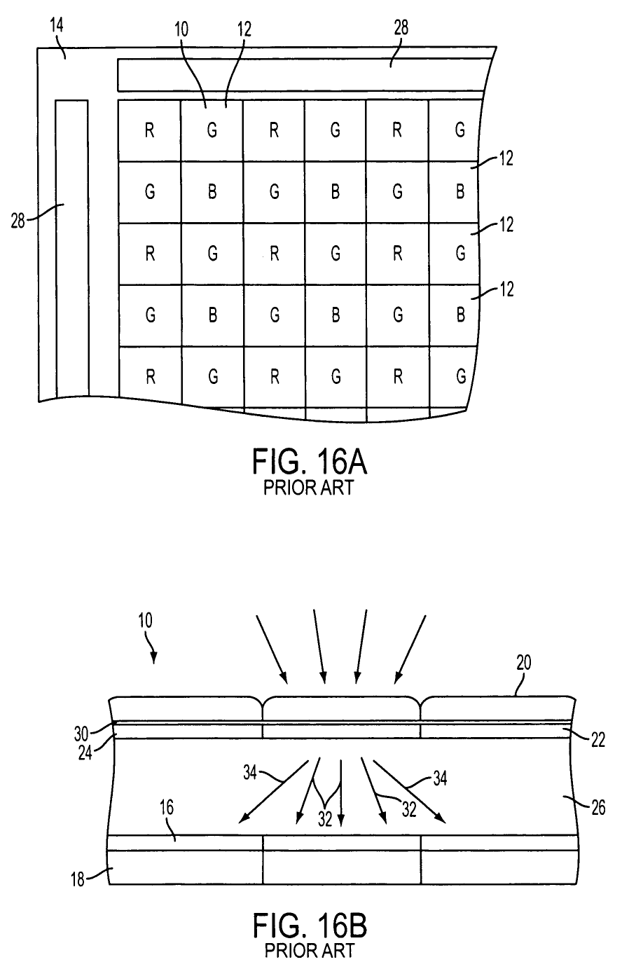

With reference to FIG. 14C, the image creation process can also be applied by pixel processing unit 500 to the imaging device 200 by first combining the signals of the three color pixel arrays 202, 204, 204 into one array having pixels with RGB (red-blue-green) signal components. The process is then performed on the combined RGB signal array. In addition, the image creation process can be performed on a conventional pixel array 10 having a Bayer pattern (FIG. 16A), with demosaiced pixels as shown in FIG. 14D.

As one example of an imaging device which can be constructed in embodiments of the invention, an imager device pixel array has an effective color image resolution of 1.2 mega pixels. The pixel array has an individual pixel size of 1.4 μm, and a horizontal Field of View of 45°. The image array is constructed as a 3×1 color sensor array (FIG. 4) with a mini-lens array 238 having a mini-lens size equal to 4.2 μm. In such a imager device, with an imaging lens focal length F=3.24 mm, and f#=3, embodiments of the invention can extend focus-free range distances from infinity (∞) to 0.2 m.

On the other hand, a conventional 1.2 mega pixel color imager device system with pixel size equal to 4.2 μm and the same lens has the focus free range covering only infinity (∞) to 1.6 m. In the embodiment of the invention described above, the dramatic extension in the focus free range—an extension of 1.4 m—is achieved by subdividing the sensor into a 3×1 color array, and using 1.4 μm pixels grouped in 3×3 clusters with the addition of a mini-lens over each cluster. The actual number of pixels in the sensor is 8.1 mega pixels, but the interpolated image resolution is 1.2 mega pixels. The excess number of pixels is used to restore out-of-focus image information.

It is interesting to note that a standard imaging module with the pixel size 1.4 μm would have very poor image quality due to strong pixel color cross-talk and charge diffusion. On the other hand, embodiments of the invention utilizing a 3×1 sensor array in combination with the image restoration techniques described takes advantage of sensor array color separation and summation over nine smaller size pixels outputs to achieve image quality equivalent to that of sensor with 4.2 μm pixel size. At the same time the object focus-free distance is advantageously reduced from 1.6 m to 0.2 m.

FIG. 15 shows in simplified form a processor system 600 which includes the imaging device 200 of the disclosed embodiments. The processor system 400 is exemplary of a system having digital circuits that could include image sensor devices. Without being limiting, such a system could include a computer system, still or video camera system 610, scanner, machine vision, vehicle navigation, video phone, surveillance system, auto focus system, star tracker system, motion detection system, image stabilization system, and other systems employing an imaging device.

The processor system 600, for example a digital still or video camera system 610, generally comprises a lens 100 for focusing an image on the pixel arrays 202, 204, 206 of an imaging device (FIG. 4), a central processing unit (CPU) 610, such as a microprocessor which controls camera and one or more image flow functions, that communicates with one or more input/output (I/O) devices 640 over a bus 660. Imaging device 200 also communicates with the CPU 610 over bus 660. The system 600 also includes random access memory (RAM) 620 and can include removable memory 650, such as flash memory, which also communicate with CPU 610 over the bus 660. Imaging device 200 may be combined with the CPU, with or without memory storage on a single integrated circuit or on a different chip than the CPU. Although bus 660 is illustrated as a single bus, it may be one or more busses or bridges used to interconnect the system components.

While various embodiments have been described above, it should be understood that they have been presented by way of example, and not limitation. For example, embodiments may be employed with any solid state imager pixel structure and associated array readout circuit. It will be apparent to persons skilled in the relevant art(s) that various changes in form and detail can be made therein.

What is claimed as new and desired to be protected by Letters Patent of the United States is:

1. An imaging apparatus comprising:
a pixel array comprising a plurality of pixels;
a first lens array comprising a plurality of first lenses over the pixel array; and
a second lens array comprising a plurality of second lenses over the first lens array, wherein each of the plurality of second lenses directs light onto more than one of the plurality of first lenses.

2. The imaging apparatus of claim 1, further comprising an imaging lens over the second lens array.

3. The imaging apparatus of claim 1, wherein each of the plurality of second lenses directs light onto a N×M cluster of the first lenses, where N and M are integers.

4. The imaging apparatus of claim 3, wherein N and M are equal to 3.

5. The imaging apparatus of claim 3, wherein edges of each of the plurality of second lenses are aligned with edges of the cluster of N×M first lenses.

6. The imaging apparatus of claim 1, further comprising optical filters disposed between the second lens array and the imaging lens.

7. The imaging apparatus of claim 1, wherein the second lens array is disposed approximately at a focal plane of the imaging lens.

8. The imaging apparatus of claim 1, wherein a numerical aperture of the plurality of second lenses is approximately equal to a numerical aperture of the imaging lens.

9. The imaging apparatus of claim 1, wherein the first lens array is disposed approximately at a focal plane of the plurality of second lenses of the second lens array.

10. The imaging apparatus of claim 1, wherein the pixel array comprises a plurality of pixel arrays on a single chip, and wherein each of the plurality of pixel arrays is a respective color pixel array.

11. The imaging apparatus of claim 9, wherein the plurality of pixel arrays comprises a green pixel array, a red pixel array and a blue pixel array.

12. The imaging apparatus of claim 1, wherein the pixel array comprises a plurality of red, green and blue pixels.

13. The imaging apparatus of claim 1, wherein color filters are provided between the imaging lens and the second lens array.

14. An imaging device, comprising:
a pixel array comprising a plurality of pixels disposed under a first lens array having a plurality of first lenses, wherein each pixel of the pixel array is disposed under a corresponding first lens of the first lens array; and
a second lens array, having a plurality of second lenses, disposed over the first lens array, and wherein said second lenses are larger than said first lenses.

15. The imaging apparatus of claim 14, wherein the pixel array comprises a plurality of pixel arrays on a single chip.

16. The imaging apparatus of claim 15, wherein each of the plurality of pixel arrays is a respective color pixel array.

17. The imaging apparatus of claim 16, wherein the plurality of pixel arrays comprises a green pixel array, a red pixel array and a blue pixel array.

18. The imaging apparatus of claim 14, wherein the pixel array comprises a plurality of red, green and blue pixels.

19. The imaging device of claim 14, further comprising an imaging lens having a focal length from the imaging lens to a focal point of the imaging lens, and wherein the second lens array is disposed approximately at the focal point of the imaging lens.

20. The imaging device of claim 14, further comprising a pixel processing unit for processing pixel signals from the array, the pixel processing unit being configured to form a plurality of different sample point pixels sets for each of a plurality of pixel groups, each of the plurality of sample pixels sets corresponding to a respective pattern of light spread on a pixel array.

21. The imaging device of claim 20, wherein each of the sample point pixel sets comprises a plurality of sample point pixels, and wherein each of the sample point pixel sets comprises a different set of sample point pixels.

22. The imaging device of claim 14, wherein each second lens of the second lens array directs light onto a N×M cluster of pixels, wherein N and M are integers greater than or equal to 2.

23. The imaging device of claim 14, wherein each second lens of the second lens array directs light onto a N×N cluster of pixels, wherein N is an integer greater than or equal to 2.

24. The imaging device of claim 23, wherein each second lens of the second lens array directs light onto a 3×3 cluster of pixels of the pixel array.

25. The imaging device of claim 22, wherein L second lenses direct light onto L clusters of pixels of the pixel array, wherein L is an integer greater or equal to 2.

26. The imaging device of claim 23, wherein L second lenses direct light onto L clusters of pixels of the pixel array, wherein L is an integer greater or equal to 2.

27. The imaging device of claim 24, wherein nine of the second lenses direct light onto nine 3×3 clusters of pixels of the pixel array.

28. The imaging device of claim 27, wherein the nine 3×3 clusters of pixels comprise an upper left cluster, an upper center cluster, an upper right cluster, a middle left cluster, a middle center cluster, a middle right cluster, a lower left cluster, a lower center cluster, and a lower right cluster.

29. The imaging device of claim 28, further comprising a pixel processing unit which defines three different sets of sampling point pixels for each 9×9 pixel group.

30. The imaging device of claim 29, wherein the pixel processing unit is configured to define a first set of sampling point pixels as follows: an upper left pixel in the middle center cluster; an upper center pixel in the middle center cluster; an upper right pixel in the middle center cluster; a middle left pixel in the middle center cluster; a middle center pixel in the middle center cluster; a middle right pixel in the middle center cluster; a lower left pixel in the middle center cluster; a lower center pixel in the middle center cluster; and a lower right pixel in the middle center cluster.

31. The imaging device of claim 30, wherein the pixel processing unit is configured to define a second set of sampling point pixels as follows: an upper left pixel in the upper left cluster; an upper center pixel in the upper center cluster; an upper right pixel in the upper right cluster; a middle left pixels in the middle left cluster; a middle center pixel in the middle center cluster; a middle right pixel in the middle right cluster; a lower left pixel in the lower left cluster; a lower center pixel in the lower center cluster; and a lower right pixel in the lower right cluster.

32. The imaging device of claim 31, wherein the pixel processing unit is configured to define a third set of sampling point pixels as follows: a lower right pixel in the upper left cluster; a lower center pixel in the upper center cluster; a lower left pixel in the upper right cluster; a middle right pixel in the middle left cluster; a middle center pixel in the middle center cluster; a middle left pixel in the middle right cluster; an upper right pixel in the lower left cluster; an upper center pixel in the lower center cluster; and an upper left pixel in the lower right cluster.

33. The imaging device of claim 29, wherein the pixel processing unit is configured to use the first, second and third sets of sample point pixels for:
summing respective intensities of the sample point pixels in each of the first, second and third sets of sample point pixels;
storing the summed values of each set of sample point pixels in respective memories;
applying an edge test to adjacent stored summed values in each memory to find sharpest edges between adjacent summed values, and outputting a respective sharpness value for each memory;
selecting and outputting one stored summed value among three stored summed values in the respective memories, based upon the sharpness values;
creating an image based on the output stored summed values.

34. The imaging device of claim 32, wherein the pixel processing unit is configured to use the first, second and third sets of sample point pixels for:
summing respective intensities of the sample point pixels in each of the first, second and third sets of sample point pixels;
storing the summed values of each set of sample point pixels in respective memories;
applying an edge test to adjacent stored summed values in each memory to find sharpest edges between adjacent summed values, and outputting a respective sharpness value for each memory;
selecting and outputting one stored summed value among three stored summed values in the respective memories, based upon the sharpness values;
creating an image based on the output stored summed values.

35. An imaging device comprising:
at least one pixel array;
a pixel processing unit for processing pixels of the at least one array, the pixel processing unit being configured to form a plurality of sets of sampling pixels, each said set comprising at least one different sampling point pixel, each of the plurality of sets of sampling pixels adapted to detect a respective spread of an image signal on the pixel array.

36. The imaging device of claim 35, wherein the plurality of sets of sampling pixels comprises three sets.

37. The imaging device of claim 35, wherein each set of sampling point pixels comprises nine sampling point pixels.

38. The imaging device of claim 35, wherein the image signal is detected on an N×M group of pixels of a pixel array, where N and M are integers greater than or equal to 2.

39. The imaging device of claim 35, wherein the image signal is detected on an N×N group of pixels of a pixel array, where N is an integer greater than or equal to 2.

40. The imaging device of claim 39, wherein the group of pixels is a 9×9 group of pixels.

41. The imaging device of claim 35, wherein the pixel processing unit is configured to use the plurality of sets of sampling pixels for:
summing respective intensities of the sample point pixels in each of the first, second and third sets of sample point pixels;
storing the summed values of each set of sample point pixels in respective memories;
applying an edge test to adjacent stored summed values in each memory to find sharpest edges between adjacent summed values, and outputting a respective sharpness value for each memory;
selecting and outputting one stored summed value among three stored summed values in the respective memories, based upon the sharpness values;
creating an image based on the output stored summed values.

42. The imaging device of claim 41, wherein the at least one pixel array comprises a green, blue and red pixel array, and the step of applying the edge test is performed on each of the pixel arrays.

43. The imaging device of claim 41, wherein the at least one pixel array comprises a green, blue and red pixel array, and the step of applying the edge test is performed only on of the pixel arrays.

44. The imaging device of claim 41, wherein the pixel array comprises a combined RGB pixel array, and the step of applying the edge test is performed the pixel array.

45. An imager device comprising:
a least a first, second and third pixel array, each for sensing a particular image color and providing respective color pixel output signals;
a pixel processing unit for selecting pixels in at least three different pixel patterns from at least one of the first, second and third pixel arrays, each pattern corresponding to a respective light spread pattern of an image on the at least one of the first, second and third pixel arrays;
the pixel processing unit being configured to sum the selected pixels of the at least three different pixel patterns for selecting one of the summed pixels of each of the at least three different pixel patterns for image construction output in accordance with edge characteristics of adjacent summed pixel patterns.

46. The imager device of claim 45, wherein the pixel processing unit is further configured to apply a respective weighting function to the selected pixels.

47. The imager device of claim 45, wherein the pixel processing unit is further configured to used to use the output summed pixels to reconstruct an image of an object.

48. An imaging device comprising:
at least one pixel array providing pixel signals; and
a pixel processing unit configured to:
receive pixel signals from the at least one pixel array;
divide the received array pixel signals into successive groups of pixels across the at least one pixel array, each successive pixel group comprising pixels in a plurality of rows and columns of the at least one pixel array;
define, for each successive pixel group across the at least one pixel array, a plurality of successive corresponding sampling pixel groups, each corresponding sampling pixel group containing a different group of pixels of said successive pixel group;
sum sampling pixels in each of said plurality of successive sampling pixel groups;
select one of said successive summed groups of sampling pixels corresponding to a pixel group which exhibits a highest edge sharpness with a neighboring summed group of sampling pixels; and
reconstruct an image using said selected groups of summed sampling pixels.

49. The imaging device of claim 48 wherein each said successive pixel group comprises an N×M group of pixels where N and M are both integers greater than 3, and each said sampling pixel group comprises an O×P pixel group, where O and P are both integers less than N and M.

50. The imaging device of claim 49 wherein said successive pixel group comprises a group of 9×9 pixels, and each said sampling pixel group comprises nine pixels of said 9×9 pixel group.

51. The imaging device of claim 48 wherein said plurality of successive corresponding sampling pixel groups comprise three sampling pixel groups.

52. The imager device of claim 48 wherein each said summed group of sampling pixels has a weighting factor associated with each pixel which is summed.

53. The imager of claim 48, further comprising a plurality of pixel arrays, each of a respective color, and wherein said pixel processing unit is further configured to:
combine pixel signals from the pixel array and process the combined signals as the received pixel signals.

54. The imager of claim 48, further comprising a plurality of pixel arrays, each of a respective color, and wherein said pixel processing unit is further configured to:
separately process pixel signals from each of said plurality of pixel arrays as the received pixel signals; and
combine reconstructed images corresponding to each of the plurality of pixel arrays to form an output image.

55. The imager device of claim 48, wherein the at least one pixel array provides pixel signals of a plurality of colors and the pixel processing unit is further configured to demosaic the pixel signals and provide the demosaided pixel signals as received pixel signals.

56. A method of capturing an image, comprising:
capturing light rays containing image information of an object with an imaging lens;
directing the light rays from the imaging lens to a plurality of first lenses of a first lens array;
directing the light rays from each of the first lenses to a cluster of second lenses of a second lens array; and
directing light from each of the second lenses to respective pixels of a pixel array.

57. The method of claim 56, wherein the directing the light rays from each of the first lenses comprises directing light rays to a cluster of N×M second lenses, wherein N and M are integers greater than or equal to 2.

58. The method of claim 56, wherein the directing the light rays from each of the first lenses comprises directing light rays to a cluster of N×N second lenses, wherein N is an integer greater than or equal to 2.

59. The method of claim 58, wherein the cluster of second lenses is a 3×3 cluster of nine second lenses.

60. The method of claim 56, wherein the pixel array comprises a plurality of pixel arrays.

61. The method of claim 58, wherein each of the plurality of pixel arrays is a respective color pixel array.

62. The method of claim 61, wherein the plurality of pixel arrays comprises a green pixel array, a red pixel array and a blue pixel array.

63. The method of claim 56, wherein the pixel array comprises a plurality of red, green and blue pixels.

64. A method of imaging an object, comprising:
providing an imager device having a pixel array comprising a plurality of pixels;
receiving light rays from an object to be imaged on the pixel array, the light rays originating at different distances from the pixel array; and
creating an image of the object using signals from the pixel array, said signals being from particular sample pixels, and wherein said sample pixels correspond to a spread of an image spot on the pixel array.

65. The method of claim 64, wherein said particular sample pixels comprise a plurality of sample pixels sets, each of the plurality of sample pixels sets corresponding to a respective amount of spread of an image spot on the pixel array.

66. The method of claim 65, wherein each of the sample point pixel sets comprises a plurality of sample pixels, and wherein each of the sample point pixel sets comprises a different set of sample point pixels.

67. The method of claim 64, wherein said sample pixels are determined from a group of M×N pixels of said pixel array, wherein M and N are integers greater than or equal to 2.

68. The method of claim 64, wherein said sample pixels are determined from a group of M×M pixels of said pixel array, wherein M is an integer greater than or equal to 2.

69. The method of claim 68, wherein said sample pixels are determined from a group of pixels comprising nine 3×3 clusters of pixels.

70. The method of claim 69, wherein the nine 3×3 clusters of pixels comprise an upper left cluster, an upper center cluster, an upper right cluster, a middle left cluster, a middle center cluster, a middle right cluster, a lower left cluster, a lower center cluster, and a lower right cluster.

71. The method of claim 70, further comprising providing a pixel processing unit which defines three different sets of sampling point pixels for each 9×9 pixel group.

72. The method of claim 71, wherein the pixel processing unit is configured to define a first set of sampling point pixels as follows: the upper left pixel in the upper left cluster; the upper center pixel in the upper center cluster; the upper right pixel in the upper right cluster; the middle left pixels in the middle left cluster; the middle center pixel in the middle center cluster; the middle right pixel in the middle right cluster; the lower left pixel in the lower left cluster; the lower center pixel in the lower center cluster; and the lower right pixel in the lower right cluster.

73. The method of claim 72, wherein the pixel processing unit is configured to define a second set of sampling point pixels as follows: the lower right pixel in the upper left cluster; the lower center pixel in the upper center cluster; the lower left pixel in the upper right cluster; the middle right pixel in the middle left cluster; the middle center pixel in the middle center cluster; the middle left pixel in the middle right cluster; the upper right pixel in the lower left cluster; the upper center pixel in the lower center cluster; and the upper left pixel in the lower right cluster.

74. The method of claim 73, wherein the pixel processing unit is configured to define a third set of sampling point pixels as follows: an upper left pixel in the middle center cluster; an upper center pixel in the middle center cluster; an upper right pixel in the middle center cluster; a middle left pixel in the middle center cluster; a middle center pixel in the middle center cluster; a middle right pixel in the middle center cluster; a lower left pixel in the middle center cluster; a lower center pixel in the middle center cluster; and a lower right pixel in the middle center cluster.

75. The method of claim 71, wherein the pixel processing unit is configured to use the first, second and third sets of sample point pixels for:
summing respective intensities of the sample point pixels in each of the first, second and third sets of sample point pixels;
storing the summed values in buffer memories;
applying an edge test algorithm to each of the stored summed values to find sharpest edges between adjacent summed values, and outputting respective sharpness values to a comparator;
selecting and outputting stored summed values, based upon the sharpness value output to the comparator;
creating an image based on the output stored summed values.

76. The method of claim 74, wherein the pixel processing unit is configured to use the first, second and third sets of sample point pixels for:
summing respective intensities of the sample point pixels in each of the first, second and third sets of sample point pixels;
storing the summed values in buffer memories;
applying an edge test to each of the stored summed values to find sharpest edges between adjacent summed values, and outputting respective sharpness values to a comparator;
selecting and outputting stored summed values, based upon the sharpness value output to the comparator;
creating an image based on the output stored summed values.

77. The method of claim 64, wherein the pixel array comprises a plurality of pixel arrays.

78. The method of claim 77, wherein each of the plurality of pixel arrays is a respective color pixel array.

79. The method of claim 77, wherein the plurality of pixel arrays comprises a green pixel array, a red pixel array and a blue pixel array.

80. The method of claim 64, wherein the pixel array comprises a plurality of red, green and blue pixels.

81. An image creation process, comprising:
selecting sample point pixels with a pixel processing unit from a pixel array for use in creating an image, wherein the selecting comprises selecting a plurality of sets of sample point pixels from a group of pixels of the pixel array, each set having at least one different sample point pixel;
reading signal information from the sample point pixels from the group of pixels into a memory; and
summing the signal information of the sample point pixels from the group of pixels in the memory.

82. The image creation process of claim 81, wherein the selecting step comprises selecting sample point pixels from a plurality of pixel arrays, each of a respective color.

83. The image creation process of claim 82, wherein each of the plurality of pixel arrays is a respective color pixel array.

84. The image creation process of claim 83, wherein the plurality of pixel arrays comprises a green pixel array, a red pixel array and a blue pixel array.

85. The image creation process of claim 81, wherein the selecting step comprises selecting sample point pixels from a pixel array comprising a plurality of red, green and blue pixels.

86. The image creation process of claim 81, wherein summing the signal information comprises summing intensities of the sample point pixels; and further comprising storing the summed intensities.

87. The image creation process of claim 86, further comprising applying an edge test to the stored summed intensities.

88. The image creation process of claim 81, further comprising:
comparing sharpness of edges of adjacent stored summed intensities;
choosing and outputting one of said summed intensities based on highest edge sharpness; and
restoring an image based on said output of summed intensities.

89. An image capture process, comprising:
capturing light rays on a pixel array of an imaging sensor, the pixel array having a plurality of pixels;
wherein specific sampling point pixels of the plurality of pixels are selected to be evaluated based on spread of an image spot across the plurality of pixels of the pixel array.

90. The image capture process of claim 89, further comprising receiving the light rays at an imaging lens, and directing the light rays from the imaging lens to first lenses of a first lens array.

91. The image capture process of claim 90, further comprising directing the light rays from each of the first lenses onto a plurality of second lenses of a second lens array.

92. The image capture process of claim 91, further comprising directing the light rays from each of the plurality of second lenses onto respective pixels of the pixel array.

93. The image capture process of claim 89, wherein the pixel array comprises a plurality of pixel arrays.

94. The image capture process of claim 93, wherein each of the plurality of pixel arrays is a respective color pixel array.

95. The image capture process of claim 93, wherein the plurality of pixel arrays comprises a green pixel array, a red pixel array and a blue pixel array.

96. The image capture process of claim 89, wherein the pixel array comprises a plurality of red, green and blue pixels.
